(19) United States
(12) Patent Application Publication
(10) Pub. No.: US 2025/0257758 A1
(43) Pub. Date: Aug. 14, 2025

(54) Screw Setting Device and Stormproof Wall Frame System

(71) Applicant: Nhi Hoang Yen Le, New Orleans, LA (US)

(72) Inventor: Nhi Hoang Yen Le, New Orleans, LA (US)

(21) Appl. No.: 19/193,838

(22) Filed: Apr. 29, 2025

(51) Int. Cl. F16B 41/00; E04B 2/70; F16B 25/00

(52) U.S. Cl. CPC F16B 41/002; F16B 25/0015; E04B 2/706

(57) ABSTRACT

A screw setting device includes a first cylindrical housing having a first cylindrical top plate with a first outer annular wall and a first inner annular wall extending perpendicularly therefrom. The inner annular wall defines a first screw setting passageway sized to receive a screw fastener. A second cylindrical housing mates with the first housing, including a second cylindrical top plate, outer annular wall, and an inner annular wall having an inner threaded surface that engages the outer threaded surface of the first inner annular wall. The screw fastener is transversely retained between slots in the top plates, which misalign when rotated to a closed position. A stormproof wall frame system includes a bottom plate with female receiving portions and screw fastener passageways, securing sawn wooden framing members. The invention enables precise and secure fastening, prevents transverse movement of fasteners, and enhances structural integrity in storm conditions.

### BACKGROUND OF THE INVENTION

### Field of the Invention

The present invention relates generally to fastener setting devices and, more particularly, to a screw setting devices and stormproof wall frame systems designed to facilitate the secure attachment of framing members in construction.

### Description of the Related Art

Traditional construction, particularly in residential building applications, require strong, storm-resistant framing. Commonly, wall frames are used which provide the primary support for a building by transferring loads down to the foundation. Wall frames form the skeleton of the structure, ensuring it can bear the necessary vertical and lateral forces. Wall frames are used to divide the interior of a building into rooms and spaces. They form the basis for both exterior and interior walls, which define the layout and functionality of the building.

One of the major challenges in construction requires correct alignment of screws to properly secure framing members to bottom plates. Misalignment can lead to poor fastening, reduced structural stability, and increased wear over time. Further, during high winds or storm conditions, framing members can experience significant lateral forces, which can cause fasteners to loosen or shift.

There exists a need for a screw fastening device that prevents unintended transverse movement of the screw fasteners once they are engaged, ensuring that the fasteners remain securely in place under stress. There is a desire for stormproof wall frame systems for providing greater resistance to the forces typically encountered in extreme weather conditions like storms and hurricane.

It is one prospect of the present invention to provide a novel screw setting device that allows for easy, precise, and secure fastening of framing members to the base plates of a wall frame system.

Another object of the present invention is to provide a screw setting device that accommodates screw fasteners and includes features that allow for easy engagement and disengagement even after the fastener device has been tightly screwed into the intended object or substrate.

As disclosed in this application, the inventor has developed a unique screw setting devices and stormproof wall frame systems that overcome the shortcomings of conventional devices and wall frame systems, ensuring consistent and durable fastening of framing members. The devices streamline the fastening process, reduces manual labor, and facilitate a flush, tight engagement with the fastened objects, increasing the structural integrity of wall frame systems.

Embodiments of the present invention provide a screw setting device as described and defined in the description below and in the annexed claims, which offer improved safety, efficiency, and effectiveness, catering to the varied needs of users in different environments.

### SUMMARY OF THE INVENTION

The following presents a simplified summary of the present disclosure in a simplified form as a prelude to the more detailed description that is presented herein.

Therefore, in accordance with embodiments of the invention, there is provided a screw setting device which includes a first cylindrical housing adapted to be grasped by a user. The first cylindrical housing includes a first cylindrical top plate. A first outer annular wall extends perpendicularly from the first cylindrical top plate, and a first inner annular wall also extends perpendicularly from the first cylindrical top plate. The first inner annular wall has an outer threaded surface and together with the first cylindrical top plate, the first inner annular wall defines a first screw setting passageway sized to receive a screw fastener.

Preferably, the device includes a second cylindrical housing designed to operatively mate with the first cylindrical housing. The second cylindrical housing comprises a second cylindrical top plate, a second outer annular wall extends perpendicularly from the top plate and a second inner annular wall also extends perpendicularly from the top plate. The second inner annular wall includes an inner threaded surface that is rotatably mateable with the outer threaded surface of the first inner annular wall. The second cylindrical top plate and the second inner annular wall define a second screw setting passageway in coaxial alignment with the first screw setting passageway.

In a preferred embodiment, the first and second cylindrical top plates comprise cylindrical planar bodies, each defining a slot therethrough, allowing for specific functionality within the screw setting process.

In a preferred embodiment, the first outer annular wall has a center axis A and is in coaxial alignment with the center axis B of the second outer annular wall. The diameter of the first outer annular wall is larger than the diameter of the second outer annular wall.

In a preferred embodiment, the diameter of the first screw setting passageway is equal to the diameter of the second screw setting passageway, providing consistent passage size through both housings.

In a preferred embodiment, the diameter of the first screw setting passageway is smaller than the diameter of the head of the screw fastener, allowing the passageway to accommodate the screw but prevent the head from passing through.

In a preferred embodiment, the first cylindrical housing is rotatable, relative to the second cylindrical housing, from an open position to a closed position.

In a preferred embodiment, a stormproof wall frame system for residential construction comprises an elongated bottom plate. The bottom plate defines a plurality of female receiving portions, each designed to receive the proximal end of a sawn wooden framing member from a plurality of such members. Each female receiving portion includes a screw fastener passageway which is adapted to allow a screw fastener to pass through. The screw fasteners are designed to securely fasten each respective sawn wooden framing member to the bottom plate and contribute to the stability and stormproof quality of the wall frame system. The system also includes a plurality of sawn wooden framing members.

In another preferred embodiment, a method of setting a screw fastener into a bottom plate of sawn lumber is disclosed. The method includes providing a first cylindrical housing that is adapted to be grasped. The first cylindrical housing includes a cylindrical top plate, with outer and inner annular walls extending perpendicularly from the top plate. The inner annular wall has an outer threaded surface, and together with the top plate, the inner annular wall forms a screw setting passageway designed to receive a screw fastener. A second cylindrical housing is provided which is designed to mate with the first housing. The second housing includes a cylindrical top plate with outer and inner annular walls extending perpendicularly from the cylindrical top plate. The inner annular wall comprises an inner threaded surface that can rotatably engage with the outer threaded surface of the first housing. Together, the second cylindrical top plate and inner annular wall define a second screw setting passageway, which aligns coaxially with the first screw setting passageway.

In a preferred embodiment, the method includes driving a portion of the screw fastener into the bottom plate of sawn lumber. Then, the first cylindrical housing is rotated to an open position relative to the second cylindrical housing. In the open position, the slots in the top plates of both housings are vertically aligned, allowing the screw fastener to be transversely received through the slots. Once the screw fastener is engaged, the first cylindrical housing is rotated to a closed position relative to the second housing. In the closed position, the slots in the top plates are vertically misaligned, which prevents the screw fastener from moving transversely out of the screw setting passageways in both housings.

In a preferred embodiment, the method of setting a screw fastener into a bottom plate of sawn lumber includes abutting the proximal end of a sawn lumber framing member against the bottom plate. Once the framing member is in place, the screw fastener is driven through the bottom plate into the proximal end of the framing member. As the screw fastener is driven, the head thereof presses against the second screw setting passageway, continuing until the proximal end of the framing member firmly abuts the bottom plate, securing the framing member.

In a preferred embodiment, the method also involves rotating the first cylindrical housing to the open position relative to the second cylindrical housing. In the open position, the screw fastener is transversely disengaged by moving the screw fastener through the aligned slots of the first and second cylindrical top plates, effectively removing the screw fastener from the passageways.

In a preferred embodiment, the method includes driving the screw fastener through the bottom plate and into the proximal end of the framing member. The driving process continues until the head of the screw fastener abuts against the outer surface of the bottom plate, ensuring the screw fastener is fully seated and the connection is secure.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which:

FIG. 1 illustrates a cross-sectional view of a screw setting device along the cutting view 1-1 of FIG. 4B, in accordance with embodiments of the invention;

FIG. 2 illustrates a cross-sectional view of the screw setting device in a closed position as connected by a screw fastener to bottom plate and to a sawn lumber framing member, in accordance with embodiments of the invention;

FIG. 3 illustrates a cross-sectional view of the screw setting device in an open position as connected by a screw fastener to bottom plate and to a sawn lumber framing member, in accordance with embodiments of the invention;

FIG. 4A illustrates a perspective view of the screw setting device in an open position, in accordance with embodiments of the invention;

FIG. 4B illustrates a perspective view of the screw setting device in a closed position, in accordance with embodiments of the invention;

FIG. 5 illustrates a perspective view showing the open position and the closed position of the screw setting device and further illustrates a cross-sectional view of the screw setting device positioned against a bottom plate of a stormproof wall frame system with an exemplary screw fastener being driven through the bottom plate and into a vertical frame member of a stormproof wall frame system, in accordance with embodiments of the present invention;

FIG. 6 illustrates perspective view of a bottom plate of a stormproof wall frame system, in accordance with embodiments of the invention;

FIG. 7 illustrates a front perspective view of a stormproof wall frame system, in accordance with embodiments of the invention; and

FIG. 8 illustrates a flow chart depicting a process of use of the screw setting device, in accordance with embodiments of the invention.

### DETAILED DESCRIPTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

Reference will now be made in detail to the present preferred embodiments of the invention, examples of which are illustrated in the accompanying drawings. Wherever possible, the same reference numerals are used in the drawings and the description to refer to the same or like parts.

As used herein, “axis” means a real or imaginary straight line about which a three-dimensional body is symmetrical. A “vertical axis” means an axis perpendicular to the ground (or put another way, an axis extending upwardly and downwardly). A “horizontal axis” means an axis parallel to the ground.

As used herein, homogeneous is defined as the same in all locations, and a homogeneous material is a material of uniform composition throughout that cannot be mechanically separated into different materials. Examples of “homogeneous materials” are certain types of plastics, ceramics, glass, metals, steel, alloys, paper, board, resins, high-density polyethylene and rubber.

In accordance with embodiments of the invention, there is provided a screw setting device for installation of lag type fasteners into respective substrates and pulling together a first material such as a wooden member to another material, such as a another wooden member, without stripping the head of the lag fastener and without over-driving the lag fastener into the material, such that a flush finish is accomplished.

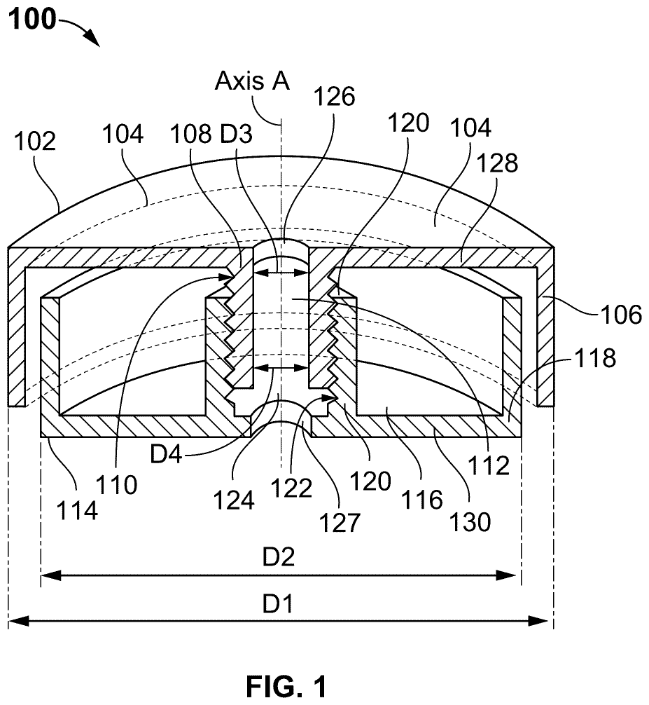

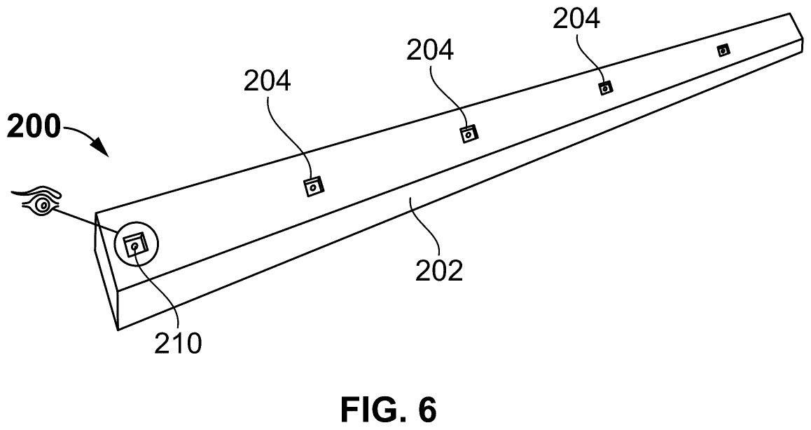

Referring to FIGS. 1-8, the basic constructional details and principles of operation of one embodiment of a screw setting device 100 according to a preferred embodiment of the present invention will be discussed.

As illustrated in FIGS. 1-8, in a preferred embodiment, the disclosed screw setting device 100 includes a first cylindrical housing 102 adapted to be grasped by a hand of a user. The first cylindrical housing 102 includes a first cylindrical top plate 104 and a first outer annular wall 106 that extends perpendicularly from the first cylindrical top plate 104, as shown in FIGS. 1-5.

The first cylindrical housing 102 includes a first inner annular wall 108 that extends perpendicularly from the first cylindrical top plate 104, as further illustrated in FIGS. 1-5. The first outer annular wall 106 of the first cylindrical housing 102 is in coaxial alignment with the first inner annular wall 108 around Axis A, as shown in FIG. 1.

As illustrated in FIGS. 1-4B, the first inner annular wall 108 includes an outer threaded surface 110, wherein the first cylindrical top plate 104 and the first inner annular wall 108 define a first screw setting passageway 112 sized to receive a screw fastener 212 therethrough. The first screw setting passageway 112 has a central axis along Axis A, as illustrated in FIG. 1.

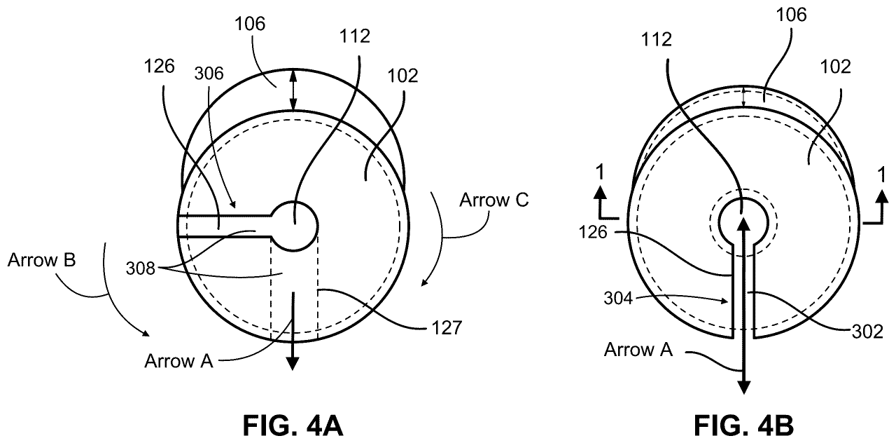

Referring to FIGS. 4A-4B, the first cylindrical top plate 104 (and a portion of the first outer annular wall 106) define a slot 126 adapted to receive a screw transversely (i.e., horizontally) therethrough, in the direction of Arrow A.

The screw setting device 100 includes a second cylindrical housing 114 designed to operatively mate with the first cylindrical housing 102, as shown in FIGS. 1 and 4-7. The second cylindrical housing 114 comprises a second cylindrical top plate 116 and a second outer annular wall 118 extending perpendicularly from the second cylindrical top plate 116. A second inner annular wall 120 extends perpendicularly from the second cylindrical top plate 116. The second inner annular wall 120 includes an inner threaded surface 122 which is adapted to be rotatably mateable with the outer threaded surface 110 of the first inner annular wall 108.

Referring to FIG. 1, the second cylindrical top plate 116 and the second inner annular wall 120 define a second screw setting passageway 124. The second screw setting passageway 124 is in coaxial alignment (shown as Axis A) with the first screw setting passageway 112. The first cylindrical top plate 104 has a cylindrical planar body 128 which defines a slot 126 therethrough. Similarly, the second cylindrical top plate 116 has a cylindrical planar body 130 which defines a slot 127 therethrough.

Referring again to FIG. 1, the first outer annular wall 106 comprises a center Axis A which is in coaxial alignment with a center Axis A of the second outer annular wall 118. Further, as illustrated, the first outer annular wall 106 comprises diameter D1 which is larger than a diameter D2 of the second outer annular wall 118. Furthermore, a diameter D3 of the first screw setting passageway 112 is equal to a diameter D4 of the second screw setting passageway 124.

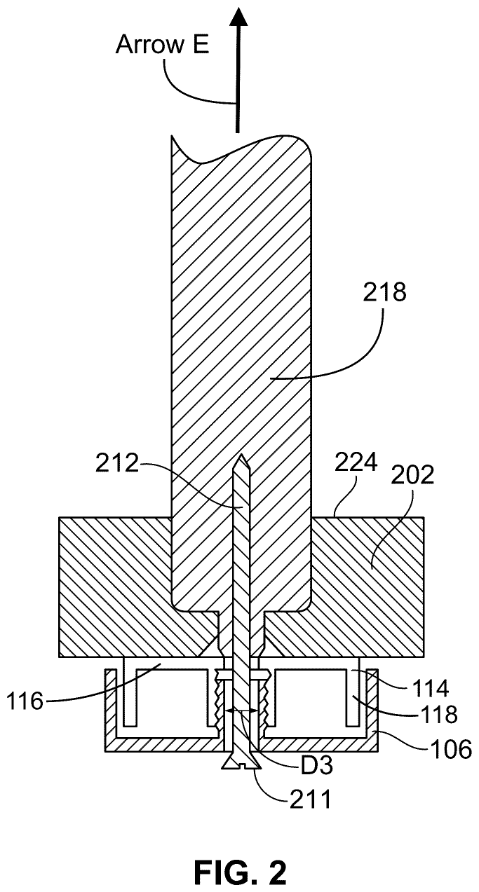

Referring now to FIG. 2, in the preferred embodiment, a diameter D3 of the first screw setting passageway 112 is characterized as having a diameter D3 smaller than a diameter of a head 211 of the screw fastener 212, as described further below.

FIG. 4A illustrates the screw setting device 100 in a closed position (i.e. locked position) 306, such that slot 126 of the first cylindrical housing 102 is not in alignment with slot 127 of the second cylindrical housing 114, and that misalignment is reflected at 308 in FIG. 4A. The slot 127 of the second cylindrical housing 114 is shown in broken lines because the second cylindrical housing 114 is disposed inside of the first cylindrical housing 102.

FIG. 4B illustrates the screw setting device 100 in an open position at 302. In the open position 302, the slot 126 of the first cylindrical top plate 104 of the first cylindrical housing 102 and the slot 127 of the second cylindrical top plate 116 of the second cylindrical housing 114 are in alignment 304. The slots 126,127 are adapted to receive the screw fastener 212 transversely (i.e., horizontally) therethrough. In other words, the

Referring to FIGS. 2-6, a portion 213 of the screw fastener 212 is partially driven into at least a portion 214 of the bottom plate 202 (or any surface that is penetrable by a lag type of screw member or bolt member). The first cylindrical housing 102 can be grasped by a user rotated (counterclockwise in the direction of Arrow B in FIG. 4A)) relative to the second cylindrical housing 114 from a closed position 306 (FIG. 4A) to an open position 302 (FIG. 4B), such that the slot 126 of the first cylindrical housing 102 is in alignment 304 with the slot 127 of the second cylindrical housing 114, as shown in FIG. 4B.

The screw fastener 212 can be transversely engaged into the first screw setting passageway 112 by movement of the screw fastener 212 through the slot 126 of the first cylindrical top plate 104 and the slot 127 of the second cylindrical top plate 116, when the system 100 is in the open position 302, such that slot 126 and slot 127 are aligned, as illustrated in FIG. 4B.

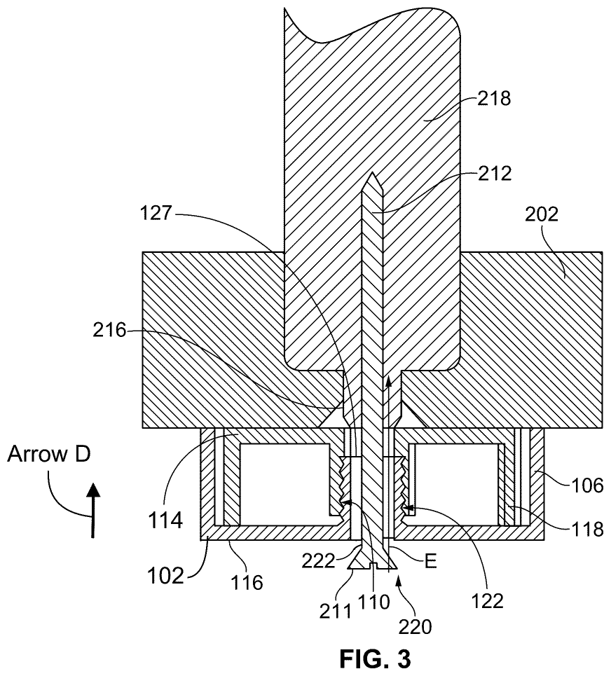

The first cylindrical housing 102 can be rotated clockwise (in the direction of Arrow C in FIG. 4A) relative to the second cylindrical housing 114, from the open position (FIGS. 3 and 4B) to a closed position 306 (FIGS. 2 and 4A). In the closed position 306, the slot 126 of the first cylindrical top plate 104 and the slot 127 of the second cylindrical top plate 116 are in the misalignment 308. The misalignment 308 is adapted to prevent transverse or horizontal movement (in the direction of Arrow A) of the screw fastener 212 out of the first screw setting passageway 112 and the second screw setting passageway 124 and respective prevent transverse or horizontal movement through the respective slots 126, 127, as illustrated in FIG. 4A.

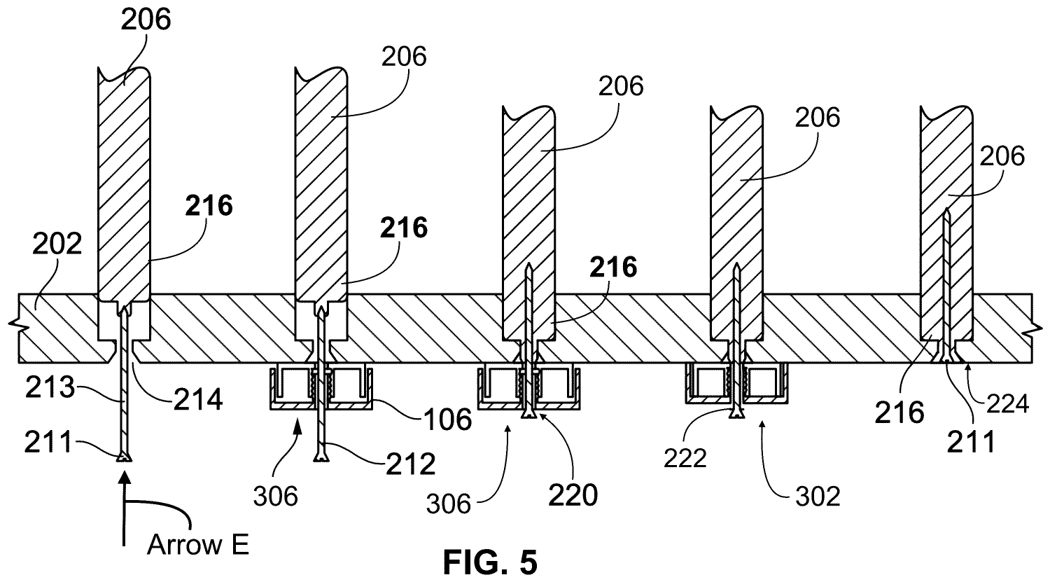

Referring to FIGS. 2-7, a proximal end 216 of a sawn lumber framing member 218 is placed atop a bottom plate 202, as shown in FIG. 5. The screw fastener 212 is partially driven (in the direction of Arrow E) through the bottom plate 202 into a proximal end 216 of the sawn lumber framing member 218 until the screw fastener 212 has a bite, leaving an exposed portion 213 of the screw fastener 212 (outside of the bottom plate 202), as illustrated in FIG. 5. The screw setting device 100 can then engage the exposed portion 213 of the screw fastener 212 by transversely (i.e. horizontally) moving the screw setting device 100 in a manner such that the exposed portion 213 of the screw fastener 212 passes transversely through the slots 126, 127 of the screw setting device 100, while the screw setting device 100 is in the open position 302 (where the slots 126 and 127 are aligned 304, FIG. 4B), until the screw fastener 212 is positioned inside the first screw setting passageway 112.

The first cylindrical housing 102 can then be rotated (relative to the second cylindrical housing 114) counterclockwise in the direction of Arrow C from the open position 302 (FIG. 4B) to the closed position 306 (FIG. 4A). While in the closed position 306, the screw fastener 212 can be further rotatably driven (using, for example, an electric drill) into the proximal end 216 of the framing member 218, such that the head 211 of the screw fastener 212 firmly presses up (at 220, FIG. 2) against the first cylindrical top plate 104 (since the diameter D3 of the first screw setting passageway 112 is smaller than the diameter of the head 211 of the screw fastener 212, as noted above) as an operative connection 220, thereby preventing an upward movement of the screw fastener 212 thereby causing the sawn lumber framing member 218 to be drawn downward toward and abut against the bottom plate 202, as illustrated in FIGS. 2 and 5. In other words, when the screw fastener 212 is then rotatably driven wherein, the head 211 of the screw fastener 212 presses up 220 against the cylindrical top plate 104 until the proximal end 216 of the sawn lumber framing member 218 firmly is pulled toward and abuts the bottom plate 202.

At that point, the screw fastener 212 firmly connects the screw setting device 100 to the bottom plate and firmly connects the bottom plate 202 to the sawn lumber framing member 206, as a tight connection, as shown in FIGS. 2 and 5. In such position, the second cylindrical top plate 116 of the second cylindrical housing 114 is firmly pressed up against the bottom plate 202 where it frictionally engages the bottom plate 202, as illustrated in FIG. 2. In that position, the screw fastener 212 has pulled together the sawn lumber framing member 218, the bottom plate 202, and the screw setting device 100 into a firm connection.

In order to free the screw setting device 100 from that firm connection, the first cylindrical housing 102 can then be rotated clockwise (relative to the second cylindrical housing 114 which is frictionally engaged with the bottom plate 202) in the direction of Arrow B (FIG. 4A) to the open position 302 (FIG. 4B).

Such rotation of the first cylindrical housing 102 into the open position 302 moves the first cylindrical housing 102 upwardly in the direction of Arrow D (FIG. 3), because the first cylindrical housing 102 is threadedly engaged with the second cylindrical housing 114, as illustrated in FIGS. 2-3. The outer threaded surface 110 of the first inner annular wall 108 of the first cylindrical housing 102 threadedly engages the second inner annular wall 120 of the second cylindrical housing 114, as previously described above, so the counterclockwise rotation (Arrow B) of the first cylindrical housing 102 (while the second cylindrical housing 114 is frictionally restrained by the bottom plate 202) causes the first cylindrical housing 102 to move upwardly, such that the first cylindrical top plate 104 of the first cylindrical housing 102 is moved away from (and freed from) the head 211 of the screw fastener 212, as shown at 222 in FIGS. 3 and 5, when the screw setting device 100 is rotated (Arrow B) into the open position 302, at which point the screw setting device 100 can be removed from its operative engagement of the screw fastener 212 altogether by transversely (horizontally) moving the screw setting device 100 (Arrow A, FIG. 4B) away from the screw fastener 212. Such moving of the screw setting device 100 away from the screw fastener 212 removes the screw fastener 212 out of the screw setting passageway 112 through the aligned slots 126, 127.

In other words, the screw fastener 212 is transversely disengaged in the direction of Arrow A (FIG. 4B) through the slot 126 of the first cylindrical top plate 104 and through the slot 127 of the second cylindrical top plate 116 when in the open position 302, while the slot 126 and slot 127 are in alignment 304, as illustrated in FIG. 4B.

Referring to FIG. 5, after the screw setting device 100 is removed as described above, then the screw fastener 212 can been driven through the bottom plate 202 into the proximal end 216 of the framing member 218 until the head 211 of the screw fastener 212 abuts an outer surface 224 of the bottom plate 202.

FIG. 5 illustrates, among other things, the sawn wooden framing member 206 being progressively drawn downwardly (via rotation of the lag screw 212) to abut firmly against the bottom plate member 202.

Referring now to FIGS. 5-8, a stormproof wall frame system 200 is used for residential construction is provided. The stormproof wall frame system 200 includes an elongated bottom plate 202 which includes a plurality of female receiving portions 204. Each female receiving portion of the plurality of female receiving portions 204 is adapted to respectively receive a proximal end 208 of each sawn wooden framing member 206 of a plurality of sawn wooden framing members used in the stormproof wall frame system 200. Each female receiving portion 204 of the plurality of female receiving portions 204 defines a screw fastener passageway 210. The screw fastener passageway 210 is adapted to receive the respective screw fastener 212 therethrough, wherein each said screw fastener 212 is adapted to respectively fasten to the respective sawn wooden framing member 206.

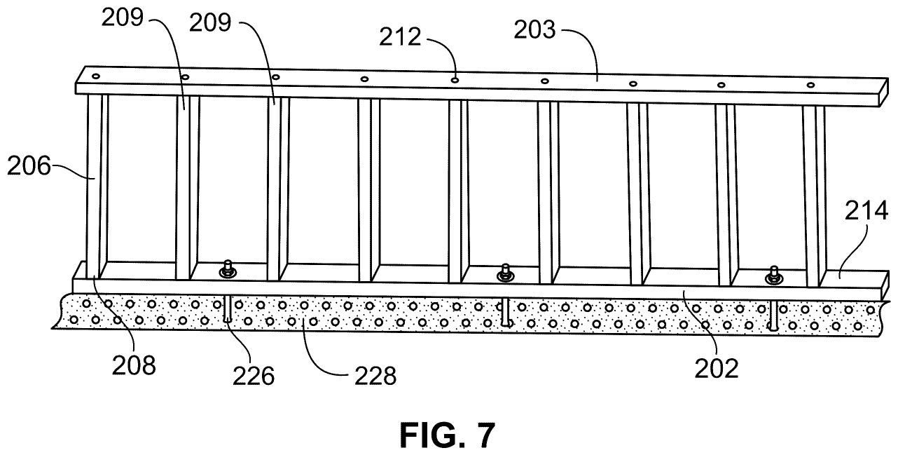

Referring to FIG. 7, steps 702-708 show different steps of using the screw setting device 100 in accordance with one embodiment of the invention. For using the screw setting device 100, the first cylindrical housing 102 and the second cylindrical housing 114 are provided and the slots 126,127 are vertically aligned for receiving the screw fastener 212 through the aligned slots 126,127, as described above. Then, the first cylindrical housing 102 is rotated relative to the second cylindrical housing 114 to transition between the open position 302 (to receive the screw horizontally through the aligned slots 126, 127), to the closed position 306 (for driving the screw fastener 212), and to the open position 302 (to remove the screw setting device 100 from the screw fastener 212).

Once a plurality of sawn wooden framing members 206 are fixed to the elongated bottom plate 202 in the manner described above, the plurality of sawn wooden framing members 206 are similarly fixed to an elongated top plate 203 in the same manner as described above for the bottom plate 202, where respective distal ends 209 (top ends) of the sawn wooden framing members 206 fixed to the elongated top plate 203 to make the stormproof wall frame system 200. The completed stormproof wall frame 200 is preferably fixed to a foundation 228 with a plurality of bolts 226, as illustrated in FIG. 7.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation within the spirit and scope of the appended claims.

The claimed invention is:

1. A screw setting device comprising:
a first cylindrical housing adapted to be grasped by a user, said first cylindrical housing comprising a first cylindrical top plate, a first outer annular wall extending perpendicularly from said first cylindrical top plate, and a first inner annular wall extending perpendicularly from said first cylindrical top plate, wherein said first inner annular wall comprises an outer threaded surface, wherein said first cylindrical top plate and said first inner annular wall define a first screw setting passageway sized to receive a screw fastener therethrough;
a second cylindrical housing designed to operatively mate with the first cylindrical housing, said second cylindrical housing comprising a second cylindrical top plate, a second outer annular wall extending perpendicularly from said second cylindrical top plate, and a second inner annular wall extending perpendicularly from said second cylindrical top plate, wherein said second inner annular wall comprises an inner threaded surface rotatably mateable with the outer threaded surface of the first inner annular wall,
wherein said second cylindrical top plate and said second inner annular wall define a second screw setting passageway in coaxial alignment Axis A with said first screw setting passageway;
the first cylindrical top plate and the second cylindrical top plate each having cylindrical planar bodies which define a respective slot therethrough, respectively.

2. The screw setting device of claim 1, wherein the first outer annular wall comprises a center axis in coaxial alignment with a center of the second outer annular wall, wherein said first annular wall comprises diameter larger than a diameter of the second outer annular wall.

3. The screw setting device of claim 1, wherein a diameter of the first screw setting passageway is equal to a diameter of the second screw setting passageway.

4. The screw setting device of claim 1, wherein a diameter of the first screw setting passageway is characterized as having a diameter smaller than a diameter of a head of the screw fastener.

5. The screw setting device of claim 1, wherein the first cylindrical housing is rotatable, relative to the second cylindrical housing, from an open position to a closed position.

6. A stormproof wall frame system for residential construction comprising:
an elongated bottom plate which defines a plurality of female receiving portions adapted to respectively receive a proximal end each sawn wooden framing member of a plurality of sawn wooden framing members, wherein each female receiving portion of the plurality of female receiving portions defines a screw fastener passageway adapted to receive a respective screw fastener therethrough, wherein each said screw fastener is adapted to respectively fasten to the respective sawn wooden framing member.

7. The stormproof wall frame system for residential construction of claim 5, further comprising the plurality of sawn wooden framing members.

8. A method of setting a screw fastener into a bottom plate of sawn lumber comprising:
a. providing a first cylindrical housing adapted to be grasped by a user,
i. said first cylindrical housing comprising a first cylindrical top plate, a first outer annular wall extending perpendicularly from said first cylindrical top plate, and a first inner annular wall extending perpendicularly from said first cylindrical top plate, wherein said first inner annular wall comprises an outer threaded surface, wherein said first cylindrical top plate and said first inner annular wall define a first screw setting passageway sized to receive a screw fastener therethrough;
b. providing a second cylindrical housing designed to operatively mate with the first cylindrical housing, said second cylindrical housing comprising a second cylindrical top plate, a second outer annular wall extending perpendicularly from said second cylindrical top plate, and a second inner annular wall extending perpendicularly from said second cylindrical top plate, wherein said second inner annular wall comprises an inner threaded surface rotatably mateable with the outer threaded surface of the first inner annular wall, wherein said second cylindrical top plate and said second inner annular wall define a second screw setting passageway in coaxial alignment with said first screw setting passageway;
i. the first cylindrical top plate and the second cylindrical top plate each having cylindrical planar bodies which define a slot therethrough;
c. driving a portion of the screw fastener into at least a portion of the bottom plate of sawn lumber;
d. rotating the first cylindrical housing to an open position relative to the second cylindrical housing, wherein in the open position, the slot of the first cylindrical top plate and the slot of the second cylindrical top plate are in a vertical alignment adapted to transversely receive screw fastener transversely therethrough;
e. transversely engaging the screw fastener through the slot of the first cylindrical top plate and the slot of the second cylindrical top plate when in the open position; and
f. rotating the first cylindrical housing to a closed position relative to the second cylindrical housing, wherein in the closed position, the slot of the first cylindrical top plate and the slot of the second cylindrical top plate are in a vertical misalignment adapted to prevent transverse movement of screw fastener out of the first screw setting passageway and the second screw setting passageway.

9. The method of setting a screw fastener into a bottom plate of sawn lumber of claim 8, further comprising:
a. abutting a proximal end of a sawn lumber framing member against the bottom plate;
b. driving the screw fastener through the bottom plate into the proximal end, wherein a head of the screw fastener presses against the second screw setting passageway until the proximal end of the sawn lumber framing member firmly abuts the bottom plate.

10. The method of setting a screw fastener into a bottom plate of sawn lumber of claim 9, further comprising
a. rotating the first cylindrical housing to the open position relative to the second cylindrical housing;
b. transversely disengaging the screw fastener through the slot of the first cylindrical top plate and the slot of the second cylindrical top plate when in the open position.

11. The method of setting a screw fastener into a bottom plate of sawn lumber of claim 9, further comprising:
a. driving the screw fastener through the bottom plate into the proximal end of the framing member until the head of the screw fastener abuts an outer surface of the bottom plate.
